(19) United States
(12) Patent Application Publication
(10) Pub. No.: US 2010/0300817 A1
(43) Pub. Date: Dec. 2, 2010

(54) BRAKE MECHANISM FOR SIMULTANEOUSLY ACTIVATING FRONT AND REAR BRAKES OF BICYCLE

(76) Inventor: Sheng-Lung Chiang, Hsinchu (TW)

Correspondence Address: RABIN & Berdo, PC, 1101 14TH STREET, NW, SUITE 500, WASHINGTON, DC, 20005, US

(21) Appl. No.: 12/472,791

(22) Filed: May 27, 2009

(51) Int. Cl. B62L 3/08

(52) U.S. Cl. 188/24.16

(57) ABSTRACT

A brake mechanism for simultaneously activating front and rear brakes of a bicycle includes a retaining base having an installation portion internally and mounted on a proper position of a body of the bicycle for connecting respectively brake cables from brake levers of the bicycle and brake cables from the front brake and the rear brake to insert into the installation portion. A brake unit with at least three disks is coaxially installed in the installation portion of the retaining base. Each of the three disks has a guiding portion for connecting the brake cables from the brake levers and the brake cables connecting to the front wheel and the rear wheel. The front brake and the rear brake may be simultaneously and evenly activated through the rotation of the three disks of the brake unit, thereby being capable of avoiding a fall-down of the bicycle.

### BACKGROUND OF THE INVENTION

1. Field of the Invention

The present invention relates generally to a brake mechanism for a bicycle, and in particular to a brake mechanism for simultaneously activating the front and rear brakes of a bicycle.

2. The Prior Arts

Referring to FIG. 1, a bicycle structure is shown. Since people pay more attention to the issues of health and environment, bicycles have become a popular means for exercise and transportation. More and more people purchase advanced bicycles for leisure, race, or daily transportation. Therefore, bodies of bicycles have designed for more easily way to ride and to achieve a higher speed. Bicycles having different functions with light weights and many shift gears, such as road bicycles, mountain bicycles, or folding bicycles, have become a mainstream of specifications.

As the maximum speed of bicycles have become higher, the forces of brakes are getting more important for safety requirements. The current brakes of bicycles are divided into two types, conventional wire-controlled cantilever brakes and higher cost disk brakes. However, no matter which type of brakes, the current brakes are designed as a front brake and a rear brake being respectively controlled by a left brake lever and a right brake lever. In FIG. 1, the positions of the front brake 1 and the rear brake 2 mounted on a bicycle are shown.

When riding a bicycle, no matter riding a road bicycle on a highway with a high speed or a mountain bicycle on a bumpy road, and no matter a cantilever brake or a disk brake, it would not cause any dangerous condition under a general manipulation. However, when riding with a high speed or sprinting on a descent, if an emergent condition happens, such as an obstruction, a macadam road, or there is a need to duck a vehicle, the rider usually grips the brake levers with reflectivity to brake the bicycle instantly. It would cause uneven brake forces on the wheels, or the rider would apply different forces to the front brake and the rear brake and cause a too low or a too high brake force to one of the wheels, especially to the front wheel. Thus, it would result in a stall or a sudden shift in gravity center and then a fall-down. The rider would be injured, fractured, dead, or bumped by the vehicles come after. Therefore, while concerning about the brake forces, it should be a priority to improve the safety when braking the bicycle instantly.

Referring to FIGS. 7 and 8, a conventional brake mechanism is shown. In consideration of the problem that it may easily cause a fall-down by individually control the front brake or the rear brake, a structure which simultaneously activates both brakes has developed. Through the manner of simultaneously activating the two brakes, it may reduce a stall and a fall-down. Although the manner of simultaneously activating the two brakes may not provide the requirements of special riding movements, such as stunts, while practical riding, this manner is a safer form of braking. A manufacturer has developed a brake mechanism which may simultaneously activate the two brakes, Taiwanese Utility Model Patent No. 590098. In which:

The brake mechanism has a base body 4 mounted on the fork at the front of the bicycle. There are two main passages 402 and two secondary passages 401 in the base body 4. An upper end or a bottom end of each passage has a joint 43 at the opening, respectively. The brake cables 10/20/30A/30B are respectively inserted into the joints and connected to two driving pistons 41 in the main passages 402 and two driven pistons 42 in the secondary passages 401. The rods of the two driving pistons 41 have annular grooves at the middle parts, and the annular grooves form annular compression chambers 404 together with the edges of the main passages 402. The rods of the two driven pistons 42 have annular grooves at the middle parts, and the annular grooves form annular compression chambers 403 together with the edges of the secondary passages 401. The walls of the two main passages 402 and the two secondary passages 401 have through holes 405.

When the brake cables 30A/30B are strained by the brake levers to proceed with a brake action, the two driving pistons 41 are upwardly activated in the annular compression chambers 404. The liquid in the annular compression chambers 404 would flow through the through holes 405 and then flow into the annular compression chambers 403 of the secondary passages 401. It forces the two driven pistons 42 to move upwardly in the annular compression chambers 403 of the two secondary passages 401. Therefore, the brake cables 10/20 are respectively driven upwardly, so that the other ends of the brake cables 10/20 would work on the front and rear brakes 1/2 to proceed with a brake action.

Two defects of the conventional brake mechanism are as follows:

1. The base body 4 which is activated by pistons together with other foregoing parts and liquid would have a rather large volume and a heavy weight. It would be a burden for the trend of the design of bicycles which is particular about lightness.
2. Through the design of two main passages 402 and two secondary passages 401 together with two driving pistons 41 and two driven pistons 42, the action might be precise, but the structure is complicated and the repair is difficult.

### SUMMARY OF THE INVENTION

The present invention relates to a brake mechanism for simultaneously activating front and rear brakes of a bicycle. The brake mechanism may simultaneously connect brake cables of the front brake and the rear brake mainly by a retaining base being mounted on a proper position of a body of the bicycle. The interior of the retaining base is a hollow installation portion. Two sidewalls of the retaining base each have a respective axle hole. An upper portion and a bottom portion of the retaining base have a first junction portion and a second junction portion, respectively. A brake unit is installed in the foregoing installation portion of the retaining base, and is axially connected in the axle holes of the two sidewalls. The brake unit comprises at least three disks. Each of the three disks has a guiding portion for connecting brake cables from brake levers and the brake cables connecting to the front wheel and the rear wheel. Each of the brake cables passes through the first junction portion and the second junction portion, respectively. The front brake and the rear brake may be simultaneously activated through the brake unit by rotating connection of the three disks, and thus the forces of the front brake and the rear brake are even, so as to enable to avoid a fall-down of the bicycle. Further, the brake unit is designed as three disks, the forces of the front brake and the rear brake may be adjusted, and different preset forces of the front brake and the rear brake may be produced.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic diagram of a conventional brake mechanism of a bicycle;

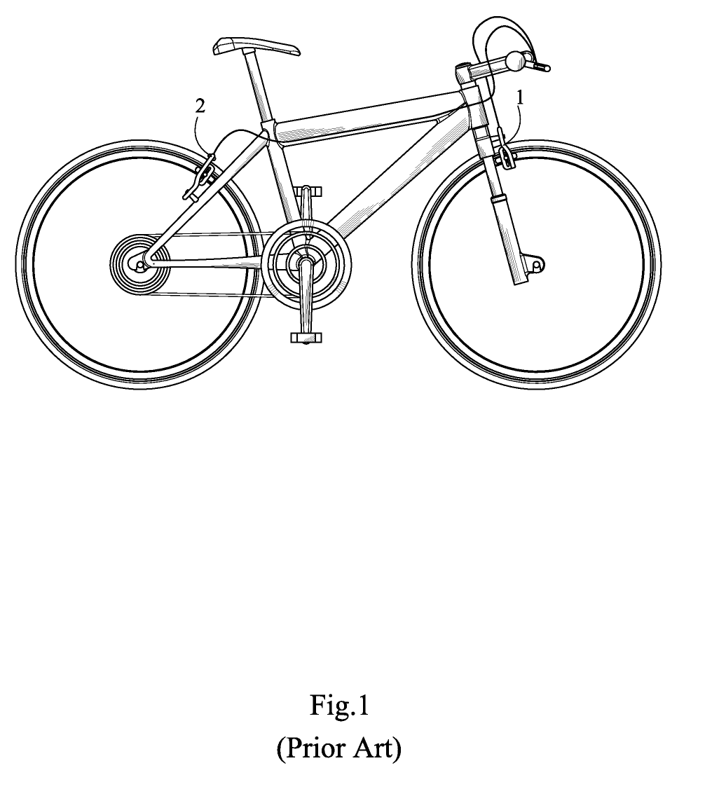

FIG. 2 is a schematic diagram of a brake mechanism installed in a bicycle according to the present invention;

FIG. 3 is a partial enlarged view of the brake mechanism of the present invention installed in a bicycle;

FIG. 4 is an exploded view of the brake mechanism according to the present invention;

FIG. 5 is a partial action view of the brake mechanism according to the present invention;

FIGS. 6A, 6B and 6C are partial cross-sectional views taken along lines 6A-6A, 6B-6B, and 6C-6C of FIG. 5, and showing the brake mechanism of the present invention, respectively;

FIG. 7 is a view of the installation of a conventional brake mechanism; and

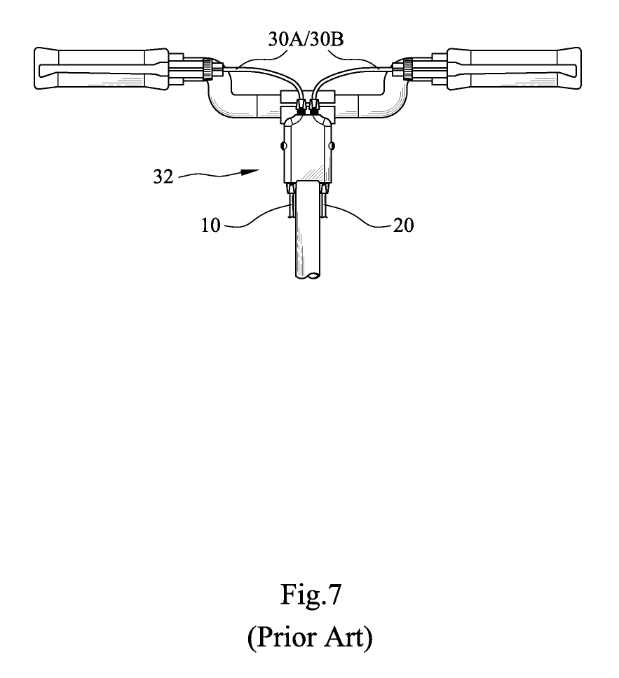

FIG. 8 is a cross-sectional view of the conventional brake mechanism shown in FIG. 7.

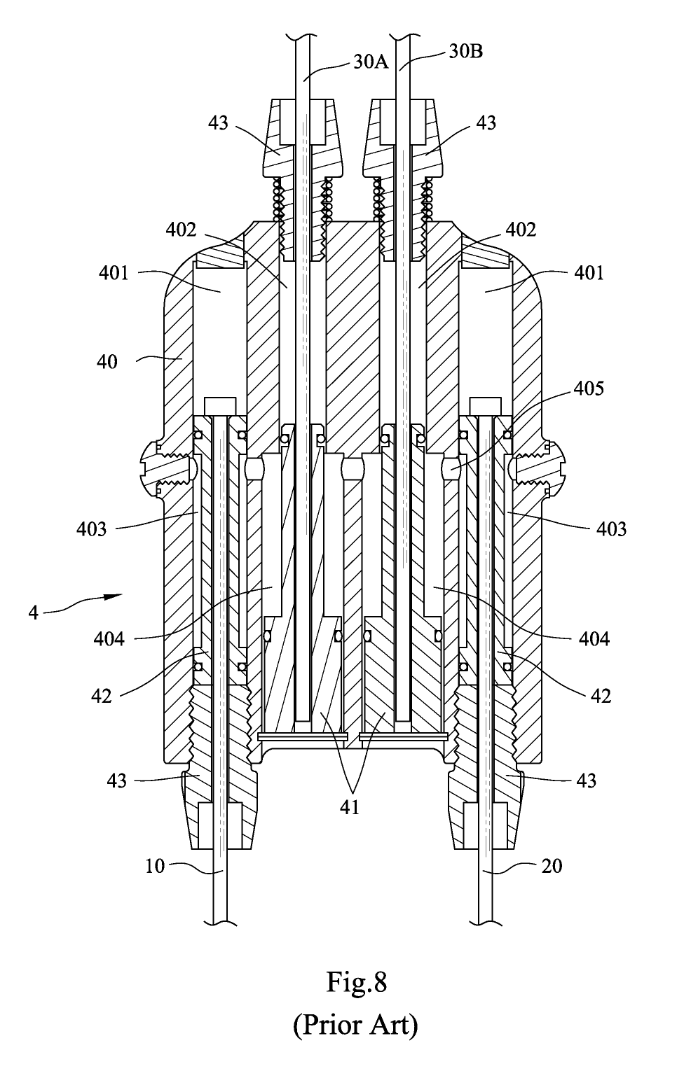

### DETAILED DESCRIPTION OF THE PREFERRED EMBODIMENT

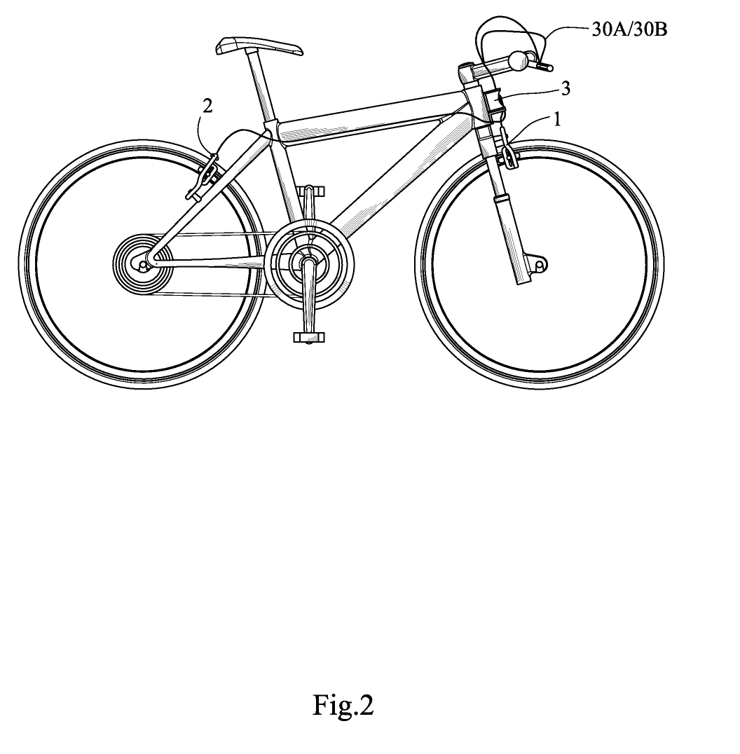

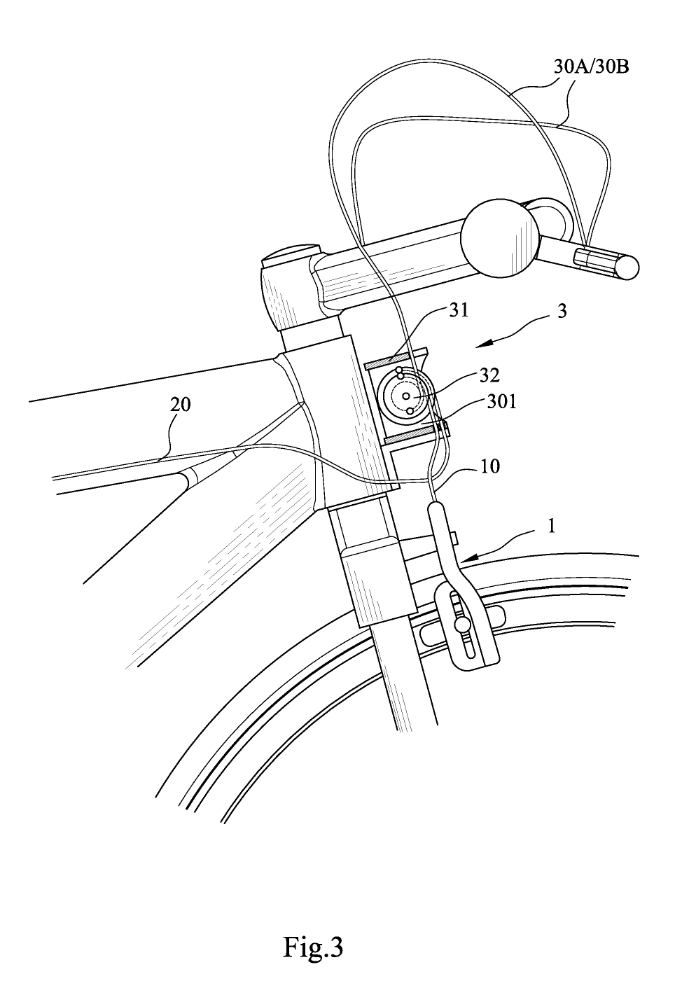

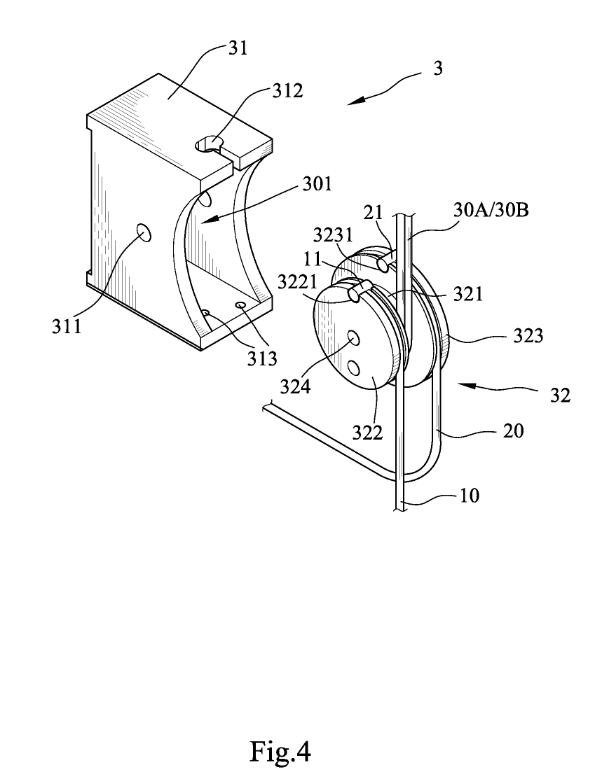

Referring to FIGS. 2, 3, and 4, assembly drawings of the preferred embodiment according to the present invention are shown. According to the present invention, the effect of simultaneously activating the front brake and the rear brake is achieved, and defects of a too large brake mechanism and difficulties of repair are effectively solved. The brake mechanism 3 according to the present invention is mounted on a proper position at the front of the body of the bicycle through a retaining base 31. The brake mechanism 3 may simultaneously connect brake cables 10/20 of the front brake and the rear brake and brake cables 30A/30B of the brake levers, so as to control the front brake 1 and the rear brake 2 to proceed with a brake action. The interior of the retaining base 31 is a hollow installation portion 301. Two sidewalls of the retaining base 31 each have a respective axle hole 311. An upper portion and a bottom portion of the retaining base 31 have a first junction portion 312 and a second junction portion 313, respectively. The brake mechanism 3 further includes a brake unit 32 installed in the foregoing installation portion 301, and is axially connected in the axle holes 311 of the two sidewalls of the retaining base 31. The brake unit 32 comprises at least three disks 321/322/323. Each of the three disks 321/322/323 has a respective guiding portion 3211/3221/3231 for connecting brake cables 30A/30B from brake levers and the brake cables 10/20 connecting to the front wheel and the rear wheel. The disk 321 connects to the brake cables 30A/30B, the disk 322 connects to the brake cable 10, and the other disk 323 connects to the brake cable 20. Each of the three disks 321/322/323 has a respective guiding groove 3212/3222/3232 along a circumference for each brake cable to be wound therein. The brake cables 30A/30B passes through the first junction portion 312, and the brake cables 10/20 passes through the second junction portion 313. The three disks 321/322/323 have a respective radius R1/R2/R3. According to a ratio of the three radii R1/R2/R3, different tensile loadings may be produced, and thus different preset forces of the front brake and the rear brake may be provided. Simultaneous rotation of the three disks 321/322/323 may simultaneously activate the front brake and the rear brake.

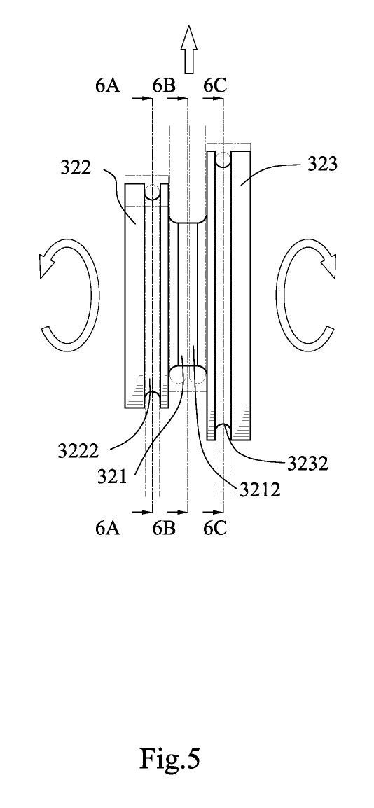

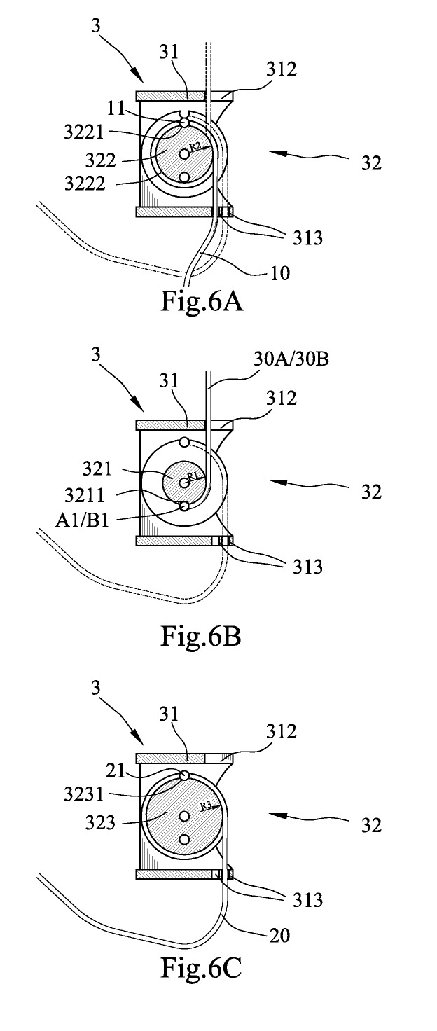

Please refer to FIGS. 5, 6A, 6B and 6C. FIGS. 6A, 6B and 6C are partial cross-sectional views taken along lines 6A-6A, 6B-6B, and 6C-6C of FIG. 5, and showing the brake mechanism of the present invention, respectively. In accordance with the aforementioned structure, when the brake mechanism 3 is strained simultaneously or respectively by the brake cables 30A/30B, the disk 321 may produce different torsions with different forces. The torsion is stronger when the brake cables 30A/30B are strained simultaneously, and the torsion is weaker when the brake cable 30A or the brake cable 30B is strained individually. Each of the circumstances may coaxially drive the two side disks 322/323 to rotate by the disk 321. When the disks 322/323 rotate, they strain the brake cables 10/20 respectively to rotate reversely and upwardly. According to the ratio of the three radii R1/R2/R3, different tensile loadings may be produced. Different ratios of the three radii R1/R2/R3 may be designed in accordance with different conditions of different kinds of bicycles. When simultaneously activate the front brake 1 and the rear brake 2, different forces may be produced by the rotations of the three disks 321/322/323, and the braking condition may be better. Further, the three disks 321/322/323 are easy to be manufactured, and may be replaced any time for the best design. According to the preferred embodiment, the guiding portions 3211/3221/3231 of the three disks 321/322/323 are designed as notches, for providing round heads of both ends of general brake cables to fasten therein. The direction of the brake cables 30A/30B fastening with the guiding portion 3211 is opposite to the direction of the brake cables 10/20 fastening with the guiding portions 3221/3231. When the brake cables 30A/30B are strained, the brake cables 10/20 may be activated by the upward rotation of the disks 322/323. The first junction portion 312 and the second junction portion 313 of the retaining base 31 may be recesses or holes for the brake cables to pass through. When the brake cables are released, the three disks 321/322/323 may return to original positions by the elastic forces of the springs of the brakes 1/2.

According to the aforementioned structure of the present invention, advantages are as follows:

1. The three disks 321/322/323 rotate coaxially, so that an effect of simultaneous activating the front brake and the rear brake may be achieved.
2. The structures of the brake unit 32 and the retaining base 31 are simple, small and light. The structures may not increase too much weight on the bicycle, and may not add too much burden to the rider.
3. The different ratios of the three radii R1/R2/R3 of the three disks 321/322/323 may be designed in accordance with different conditions of different kinds of bicycles, and different forces of the brakes may be preset. Also, replacement and processing are easy, and thus the application can be better.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A brake mechanism for simultaneously activating front and rear brakes of a bicycle, comprising:
a retaining base having an installation portion internally, wherein the retaining base is mounted on a proper position of a body of the bicycle for connecting respectively brake cables from brake levers of the bicycle and brake cables from the front brake and the rear brake to insert into the installation portion; and
a brake unit with at least three disks coaxially installed in the installation portion of the retaining base, the disks each having a respective radius and connecting the brake cables of the brake levers, the front brake and the rear brake to proceed with a brake action.

2. The brake mechanism according to claim 1, wherein the middle disk of the three disks connects to the brake cables of the brake levers, and the two side disks connect to the brake cables of the front brake and the rear brake, respectively.

3. The brake mechanism according to claim 1, wherein the retaining base has axle holes on two sidewalls of the installation portion for the three disks axially connecting between the two axle holes to rotate.

4. The brake mechanism according to claim 1, wherein an upper portion and a bottom portion of the retaining base have a first junction portion and a second junction portion, respectively, the first junction portion allows the brake cables of the brake levers to pass through, and the second junction portion allows the brake cables of the front brake and the rear brake to pass through.

5. The brake mechanism according to claim 4, wherein the first junction portion and the second junction portion are recesses or holes for the brake cables to pass through.

6. The brake mechanism according to claim 1, wherein the three disks are one-piece-formed rounds having a respective radius.

7. The brake mechanism according to claim 5, wherein each of the three disks has a guiding portion at a position fastening with an end round head of the brake cable.

8. The brake connecting mechanism according to claim 5, wherein each of the three disks has a guiding groove along a circumference for the brake cable to be wound therein.
